(19) United States
(12) Patent Application Publication
(10) Pub. No.: US 2002/0157685 A1
(43) Pub. Date: Oct. 31, 2002

(54) Washing method, method of manufacturing semiconductor device and method of manufacturing active matrix-type display device

(76) Inventor: Naoya Hayamizu, Yokohama-shi (JP)

Correspondence Address: FINNEGAN, HENDERSON, FARABOW, GARRETT &, DUNNER LLP, 1300 I STREET, NW, WASHINGTON, DC, 20005, US

(21) Appl. No.: 09/817,197

(22) Filed: Mar. 27, 2001

(30) Foreign Application Priority Data
Sep. 11, 2000 (JP) 2000-275156
Mar. 26, 2001 (JP) 2001-087197

(51) Int. Cl. B08B 3/12

(52) U.S. Cl. 134/1; 134/1.3

(57) ABSTRACT

In an ultrasonic washing method of washing a thing to be washed by supplying ultrasonic-wave-applied cleaning fluid to the thing, the ultrasonic wave is applied to the cleaning fluid in such a manner that the ultrasonic wave is turned on and off repeatedly at specific time intervals.

### CROSS-REFERENCE TO RELATED APPLICATION

This application is based upon and claims the benefit of priority from the prior Japanese Patent Application No. 2000-275156, filed Sep. 11, 2000, the entire contents of which are incorporated herein by reference.

### BACKGROUND OF THE INVENTION

1. Field of the Invention

This invention relates to an ultrasonic oscillation power supply used for the precise washing of semiconductors, liquid-crystal displays, or electronic devices.

2. Description of the Background Art

In semiconductor manufacturing processes, minute particles of dust are one of the major causes of a decrease in yield. Thus, in the manufacturing processes of semiconductors, liquid-crystal displays, or electronic devices, particles of the submicron order attached to semiconductors, liquid-crystal displays, or electronic devices are washed away before and after various micro-fabrications.

Generally, in those washings, both chemical washing that uses chemical liquid as cleaning fluid and physical washing, such as ultrasonic washing that applies ultrasonic waves to the cleaning fluid are used.

In the washing process, the size of particles that have to be removed is of the order of 0.1 μm. Metal ions have to be prevented from dissolving in the cleaning fluid. The widely used ultrasonic processing apparatus in such washing processes are of the batch-processing type and sheet-processing type. With the batch-processing type ultrasonic processing apparatus, a washing tub in which things to be washed, such as semiconductors, liquid-crystal displays, or electronic devices, are put is filled with treatment liquid and ultrasonic waves are emitted from an ultrasonic vibrator mounted together with a diaphragm on the underside or side face of the washing tub, thereby applying ultrasonic vibrations to the treatment liquid, which then does washing.

When a size of a glass substrate or that of a semiconductor substrate becomes large, it is difficult to put glass substrates or semiconductor substrates in units of, for example, 25 substrates in a single carrier and process them simultaneously in the batch-processing type. For this reason, the sheet-processing type that processes substrates one by one is often used. With the sheet-processing type, works (things to be processed) are usually transferred over a conveyer, in which process, various necessary processes including washing are carried out.

The sheet-processing type washing unit has a hollow body with a slit in it. A treatment liquid feed pipe is connected to the body. The washing unit is so constructed that the treatment liquid supplied from the feed pipe into the body flows out of the slit.

In the body, there is provided a diaphragm made up of a thin metal plate, quartz plate, or sapphire etc. along the flow path of the treatment liquid. To the diaphragm, a vibrator is secured with adhesive. Although the resonant frequency of the vibrator was usually in the range from 25 to 100 kHz in the past, ultrasonic waves in the MHz band have recently been widely used because they do minor damage to the washed things. A voltage is applied to the vibrator, causing the diaphragm to vibrate at ultrasonic frequency, which then causes the ultrasonic vibration of the treatment liquid flowing into the body. The treatment liquid flowing from the slit then washes the treated things.

Recently, the patterns formed on a semiconductor substrate or a liquid-crystal display unit have been getting more microscopic. It has been verified that even ultrasonic waves in the MHz band, which were said to cause minor damage, cause major damage to microscopic patterns. Furthermore, it has also been verified that ultrasonic waves do damage to the silicon crystals forming a semiconductor substrate.

Damage to those microscopic patterns or damage to silicon crystals decreases the product yield seriously. To decrease the damage, the lowering of the ultrasonic power can be considered. A decrease in the ultrasonic power would lower the efficiency in removing particles attached to the surface of the semiconductor substrate, with the result that the remaining particle would decrease the product yield.

### BRIEF SUMMARY OF THE INVENTION

The object of the present invention is to provide a washing method of causing no damage to the microscopic patterns formed on processed things, such as semiconductors, liquid-crystal displays, or electronic devices, without decreasing the efficiency in removing particles attached to the surface of the processed things, a method of manufacturing semiconductor devices, and a method of manufacturing active matrix-type display devices.

An ultrasonic washing method according to the present invention, which is an ultrasonic washing method of washing a thing to be washed by supplying ultrasonic-wave-applied cleaning fluid to the thing, is characterized by applying the ultrasonic wave to the cleaning fluid in such a manner that the ultrasonic wave is turned on and off repeatedly at specific time intervals.

Preferable embodiments of the above ultrasonic washing method are as follows:

(1) The ultrasonic wave is superimposed on a pulse-like carrier wave.

(2) The frequency of the carrier wave is lower than the oscillation frequency of the ultrasonic wave.

(3) The oscillation frequency of the ultrasonic wave is 0.6 MHz or higher.

(4) The duty ratio of the carrier wave is 80% or less.

Another ultrasonic washing method according to the present invention is characterized by comprising a first step of washing a thing to be washed by applying a first ultrasonic wave, and a second step of washing the thing by applying a second ultrasonic wave.

Preferable embodiments of the above ultrasonic washing method are as follows:

(1) The first ultrasonic wave differs from the second ultrasonic wave in any one of phase, wavelength, and amplitude.

(2) The wavelength of the second ultrasonic wave is different from an integral multiple of the wavelength of the first ultrasonic wave or from 1/n (n is an integer) of the wavelength of the first ultrasonic wave.

(3) The first ultrasonic wave and second ultrasonic wave are applied to the thing for washing, while being alternated at predetermined time intervals.

(4) The oscillation frequency of the ultrasonic wave is 0.6 MHz or higher.

Still another ultrasonic washing method according to the present invention is characterized by comprising a first step of washing a thing to be washed by applying an ultrasonic wave of a first wavelength and a second step of washing the thing by applying an ultrasonic wave of a second wavelength different from an integral multiple of the first wavelength or from l/n (n is an integer) of the first wavelength.

A semiconductor device manufacturing method according to the present invention is characterized by comprising a first step of washing a surface at which a pattern including an island-like structure with a width of 0.2 μm or less and an aspect ratio of 1.0 or more has been formed by applying a first ultrasonic wave, and a second step of applying a second ultrasonic wave for washing.

Still another semiconductor device manufacturing method according to the present invention is characterized by comprising a first step of washing a surface at which metal wires are exposed by applying a first ultrasonic wave, and a second step of applying a second ultrasonic wave for washing.

In each of the above semiconductor device manufacturing devices, it is desirable that the first ultrasonic wave should differ from the second ultrasonic wave in any one of phase, wavelength, and amplitude.

A method of manufacturing matrix-type display devices according to the present invention is characterized by comprising a first step of washing a surface at which Si or metal wires are exposed by applying a first ultrasonic wave, and a second step of applying a second ultrasonic wave for washing. In this method, it is desirable that the first ultrasonic wave should differ from the second ultrasonic wave in any one of phase, wavelength, and amplitude.

The above washing methods, embodiments, and manufacturing methods may be combined suitably or used separately.

As described above, with the present invention, it is possible to perform precise ultrasonic washing without causing damage to a thing to be washed.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIGS. 1A to 1F are pictorial diagrams of the mechanism of the principle of washing;

FIG. 2 is an explanatory diagram of damage caused to a silicon wafer;

FIGS. 3A to 3C are waveform diagrams of carrier waves;

FIG. 4 is a graph showing the dependence of damage on the frequency of carrier wave;

FIGS. 5A to 5D are explanatory diagrams of the mechanism for estimating the occurrence of damage;

FIGS. 6A to 6F are explanatory diagrams of the mechanism for estimating the occurrence of damage;

FIG. 7 is a graph showing the dependence of damage on pulses per waveform;

FIG. 8 is a graph showing the relationship between the frequency of carrier wave and the particle removing capability;

FIG. 9 shows a waveform of ultrasonic pulses applied in a washing method according to a second embodiment of the present invention;

FIG. 10 shows the defects resulting from the application of the washing method of the second embodiment to crystals;

FIG. 11 shows the defects resulting from the application of the washing method of the second embodiment to the manufacture of the active areas of semiconductor devices;

FIG. 12 shows the defects resulting from the application of the washing method according to the second embodiment to the manufacture of liquid-crystal displays;

FIG. 13 shows a waveform of ultrasonic pulses applied in a washing method according to a third embodiment of the present invention;

FIG. 14 shows the defects resulting from the application of the washing method of the third embodiment to crystals;

FIG. 15 shows the defects resulting from the application of the washing method of the third embodiment to the manufacture of the active areas of semiconductor devices;

FIG. 16 shows the defects resulting from the application of the washing method of the third embodiment to the manufacture of liquid-crystal displays;

FIG. 17 shows a waveform of ultrasonic pulses applied in the washing method according to a fourth embodiment of the present invention;

FIG. 18 shows the defects resulting from the application of a washing method according to a fifth embodiment of the present invention to crystals;

FIG. 19 shows the defects resulting from the application of the washing method according to a sixth embodiment of the present invention to the manufacture of the active areas of semiconductor devices;

FIG. 20 shows the defects resulting from the application of a washing method according to a seventh embodiment of the present invention to the manufacture of liquid-crystal displays;

FIGS. 21A to 21C schematically show the processes of manufacturing semiconductor devices to which the present invention is applied; and

FIG. 22 is a pictorial diagram of an ultrasonic washing apparatus.

### DETAILED DESCRIPTION OF THE INVENTION

Hereinafter, referring to the accompanying drawings, embodiments of the present invention will be explained.

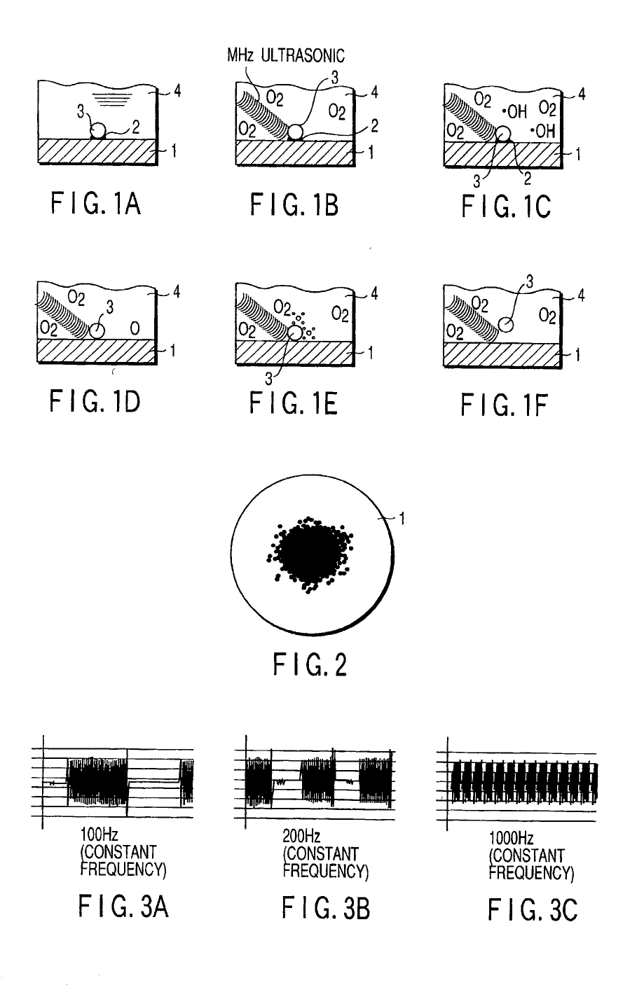

The mechanism of the principle of physical washing using ultrasonic waves according to the present invention will be explained by reference to the pictorial diagrams in FIGS. 1A to 1F.

A particle 3 adheres to a thing 1 to be washed, such as a semiconductor, liquid-crystal display, or electronic device, via organic contaminant 2 (FIG. 1A). Cleaning fluid 4 (e.g., pure water) is caused to flow over the surface of the thing 1 to be washed. Ultrasonic waves of, for example, 1.6 MHz are projected from an ultrasonic washing unit (not shown) to the surface of the thing in such a manner that they act on the particle 3 attached to the surface or the organic contaminant 2 (FIG. 1B). Projecting ultrasonic waves to the cleaning fluid 4 produces OH radicals in the cleaning fluid 4 (FIG. 1C). The produced OH radicals subject the organic contaminant 2 attached to the surface of the thing 1 to oxidative destruction (FIG. 1D). Then, the vibration caused by the projection of ultrasonic waves and the shock wave of microcavitation make the particle 3 separate from the thing 1 (FIG. 1E). The particle 3 lifts off the thing 1, which completes the washing (FIG. 1F).

Damage caused in ultrasonic washing to which a first embodiment of the present invention is applied will be explained. The first embodiment is characterized by applying ultrasonic waves in such a manner that they are turned on and off repeatedly, not applying ultrasonic waves continuously to the thing to be washed.

Explanation will be given on the basis of the result of doing the ultrasonic washing of a thing to be washed under the following conditions:

Sample to be washed: Silicon wafer p-type {1,0,0} plane

Washing machine: Sheet spin washing machine

Processing condition: 1% dilute fluoric acid solution (DHF) 30 sec

deaerated water 1.6 MHz 10 min

ozone water 1.6 MHz 60 sec

1% DHF 30 sec

ozone water rinse 10 sec

spin dry 30 sec

Ultrasonic output condition: Power supply output 30W

Damage caused to a wafer in washing the silicon crystals of a silicon wafer (semiconductor substrate), a thing 1 to be washed, under those conditions will be explained by reference to FIG. 2. After a p-type {1,0,0} plane hydrogen annealed silicon wafer 1 was treated with DHF, it was subjected to MHz washing for ten minutes. The ultrasonic vibration frequency is preferably 0.6 MHz or higher.

At this time, if ultrasonic waves in the MHz band driven by continuous waves in a normal driving method are applied to the silicon wafer 1, damage caused by a crack 13 of up to about 1 μm long might appear at the surface of the central part of the silicon wafer 1. It was verified that this phenomenon occurred similarly even when driving was done using the ultrasonic wave in the MHz band on which a 100-Hz carrier wave was superimposed.

Furthermore, experiments were performed by increasing the frequency of the carrier wave superimposed on the supersonic wave in the MHz band from 100 Hz of FIG. 3A to 200 Hz of FIG. 3B, to 1000 Hz of FIG. 3C, and further to 10000 Hz (not shown).

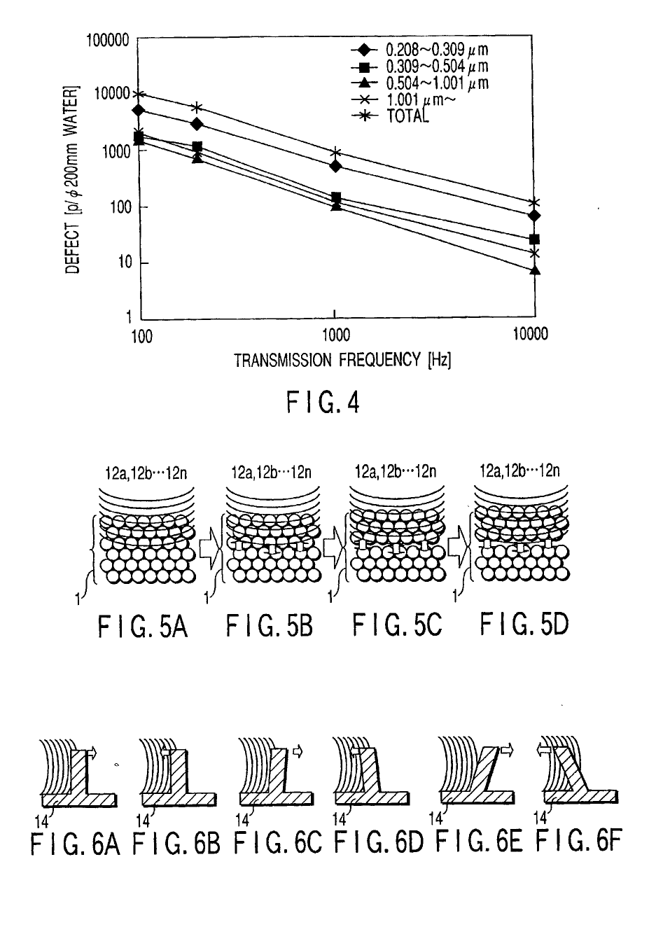

FIG. 4 is a graph showing the result of the experiments. From the graph, it is verified that as the frequency of the carrier wave increases, the number of defects decreases. The frequency of the carrier wave has only to be a value smaller than the resonant frequency of the vibrator that produces washing ultrasonic waves.

The cause of the phenomenon will be explained by reference to the pictorial diagrams of FIGS. 5A to 5D, paying attention to a given point on a silicon wafer. When ultrasonic pulses are applied to the point continuously, the ultrasonic wave penetrates to a specific depth of the silicon wafer 1 (FIG. 5A). The silicon crystals 12a, 12b, . . . , 12n in the region into which the supersonic wave has penetrated are vibrated by the ultrasonic wave, with the result that their amplitude gets larger gradually as a pendulum swings. On the other hand, although the silicon crystals in the region into which no ultrasonic wave penetrates are not vibrated directly by the ultrasonic wave, they are vibrated as the result of the vibration of the silicon crystals in the ultrasonic-wave-penetrated region. At the boundary between two regions, the silicon crystals 12a, 12b, . . . , 12n begin to crack (FIG. 5B). When the application of the ultrasonic wave is continued further, the crack in the boundary gets larger (FIG. 5C). When the crack in the boundary grows still larger, a break occurs at the boundary, leading to a crack 13, which causes damage (FIG. 5C).

Next, such a structure as a wiring pattern will be explained by reference to the pictorial diagrams of FIGS. 6A to 6D. When ultrasonic waves are applied to a structure 14, the vibration of the ultrasonic waves vibrates the structure 14 in the direction in which the ultrasonic waves advance and in the opposite direction (FIGS. 6A and 6B). When ultrasonic waves are further applied to the same place on the structure, the vibration of the structure 14 is amplified by a pendulum swinging and becomes greater (FIGS. 6C and 6D). When the amplitude gets larger, damage is caused by fracture (FIGS. 6E and 6F).

From these, it can be considered that, when raising the frequency of the carrier waves decreases the number of pulses of the ultrasonic wave applied continuously in one application, the amplified amplitude can be decreased in the time when the ultrasonic pulses are not applied.

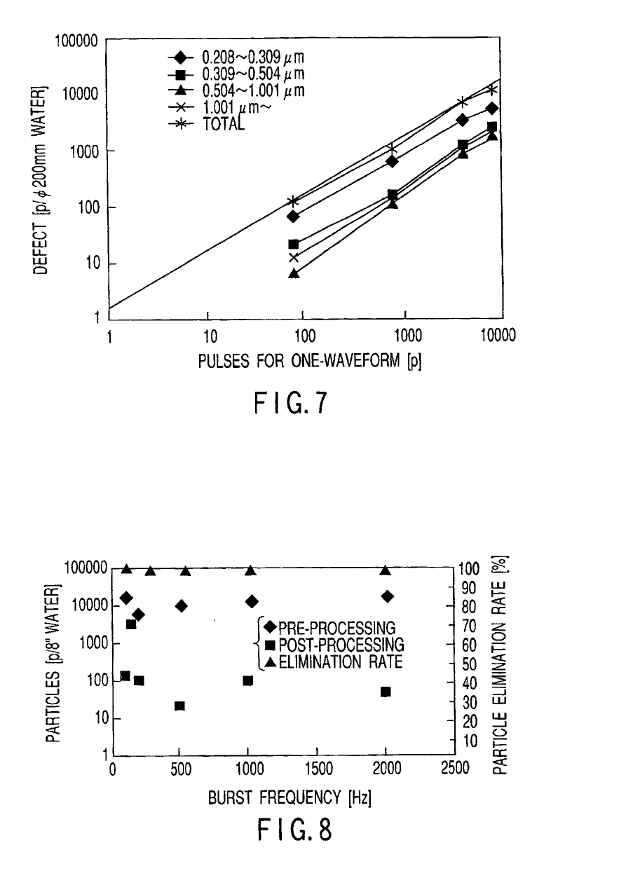

FIG. 7 is a graph showing the dependence of damage on pulses per waveform. In the graph, the smaller the number of pulses per waveform, the less damage to the crystals becomes, regardless of the size of damage.

Therefore, to limit ultrasonic waves applied continuously to one point on the thing to be washed, the waveform of a carrier wave on which the high resonant frequency is superimposed is limited. With this limitation, the number of pulses applied continuously in one round to one point on the thing to be washed is set and the alleviation time is given between the present pulse applying time and the next pulse applying time, which prevents an increase in the amplitude.

FIG. 8 is a graph showing the result of experiments conducted about the frequency of the carrier wave and the particle removing capability. It was verified that the particle removing capability does not differ with the frequency, provided that the frequency of the carrier wave is equal to or lower than 2500 Hz.

The result of each of the above experiments has shown that the frequency of the carrier wave has only to be lower than the resonant frequency of the vibrator that produces ultrasonic waves. Generally, the practical range of the frequency of the carrier wave is 1000 Hz or higher. In the case of things more immune to damage, such as amorphous substance, as low as about 100 Hz may be allowed. Conversely, things less immune to damage, such as wiring patterns, the practical range of the frequency of the carrier wave is 10000 Hz or higher.

As for the duty ratio (applying time/repetitive period time), a specific place of a thing to be washed starting to swing because of a pendulum swinging is considered to stop in almost the same time as that during which it is swung. Therefore, it is desirable that the duty ratio should be equal to or less than 50%. Since decreasing the duty ratio too much would limit the power of ultrasonic waves applied during a unit time and the amplitude need not necessarily be decreased until the specific place has come to a stop, the practical range of the duty ratio is equal to or less than about 80%, depending on the structure and material of the thing to be washed.

In the first embodiment, ultrasonic waves are applied in such a manner that they are turned on and off repeatedly. In the embodiments explained below, methods of reducing damage without turning on and off ultrasonic waves will be explained.

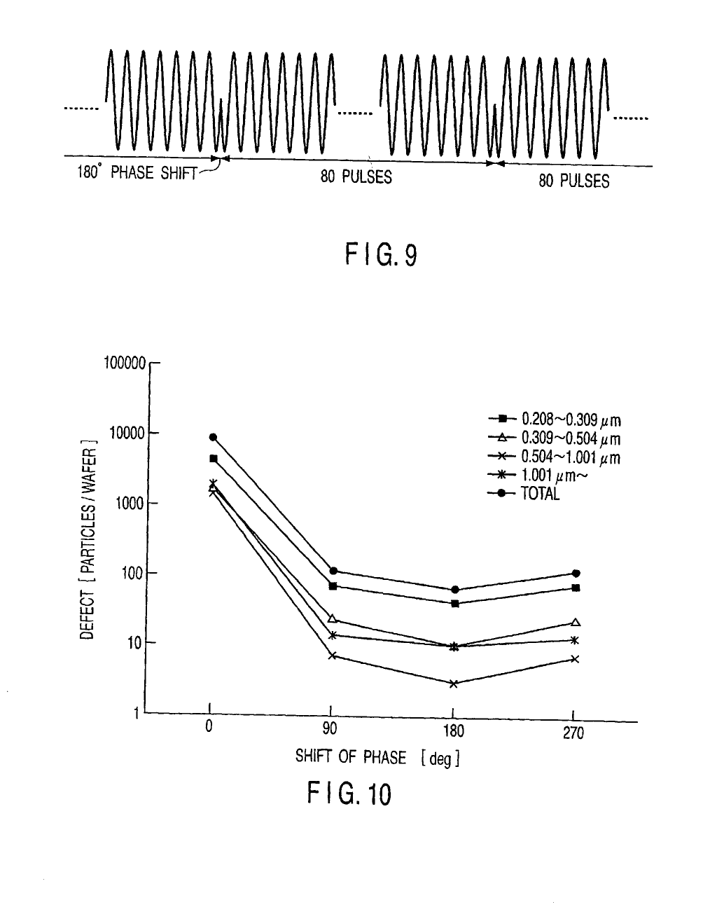

A second embodiment of the present invention will be explained by reference to FIG. 9. FIG. 9 shows a waveform of supersonic pulses applied in a washing method in the second embodiment. In the second embodiment, ultrasonic waves are not turned on and off and their phase is shifted 180 degrees during the continuous application of ultrasonic waves. In FIG. 9, the phase shifts 180 degrees at intervals of 80 pulses. From FIG. 10, it is seen that use of such an ultrasonic-wave applying method enables each of a 90-degree phase shift, a 180-degree phase shift, and a 270-degree phase shift to reduce the number of defects to 1/100 of that in the continuous application of ultrasonic waves with no shift in the phase. The reason is considered to be that, although the continuous application causes damage as explained in FIGS. 5A to 6F, changing the phase in the middle acts so as to cancel the resonance, leading to a decrease in the number of defects.

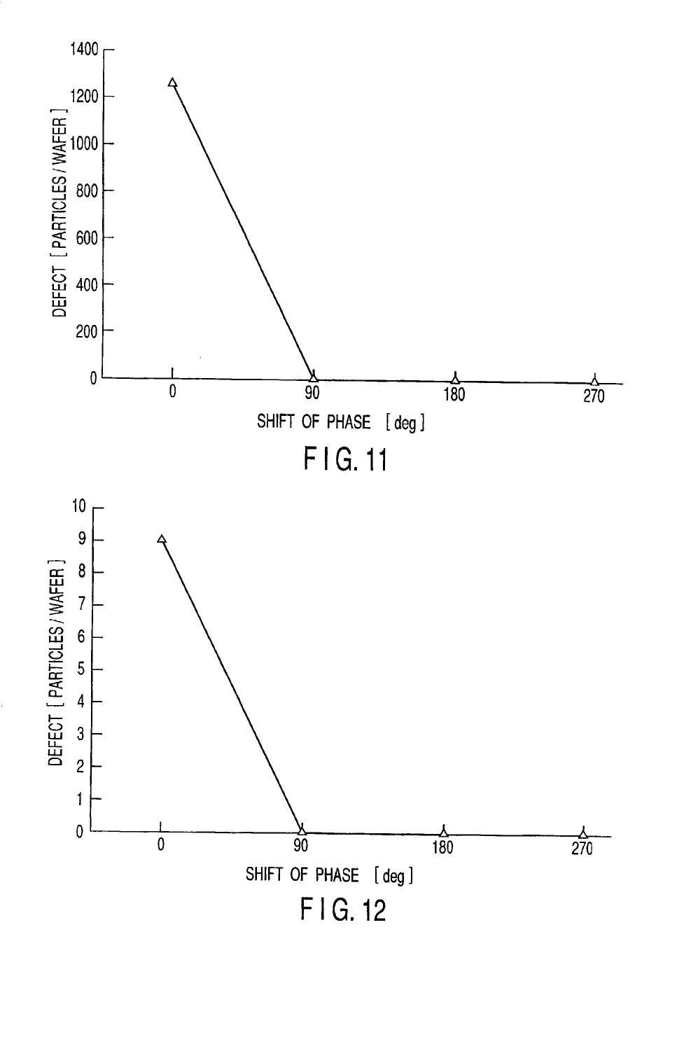

FIGS. 11 and 12 show the defects resulting from the application of an ultrasonic-wave applying method according to the second embodiment to the manufacture of the active areas of semiconductor devices (e.g., DRAMs) and liquid-crystal displays. In FIG. 11, more than 1200 defects/wafer in the pattern reduces to almost 0. In FIG. 12, more than 9 defects/wafer in the pattern decreases to almost 0. Consequently, with the second embodiment, it is possible to remove particles effectively, while reducing defects in the pattern remarkably.

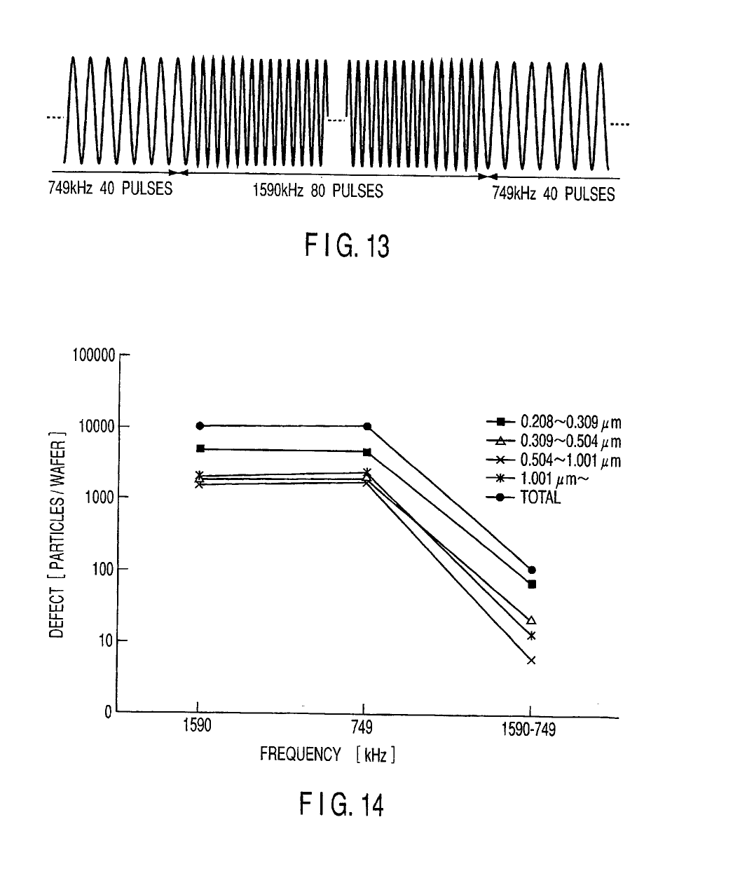

A third embodiment of the present invention will be explained by reference to FIG. 13. FIG. 13 shows a waveform of ultrasonic pulses applied in a washing method in the third embodiment. In the third embodiment, the pulse width is varied at predetermined time intervals, while the phase of ultrasonic waves is allowed to remain unchanged. In FIG. 13, the application of pulses alternates between 80 pulses at 1590 kHz and 40 pulses at 749 kHz. As shown in FIG. 14, use of such a pulse-applying method reduces the number of defects to almost 1/100 of that in the continuous application of pulses with the same pulse width, as explained in the second embodiment. The reason is considered to be that changing the phase in the middle acts so as to cancel the resonance, leading to a decrease in the number of defects.

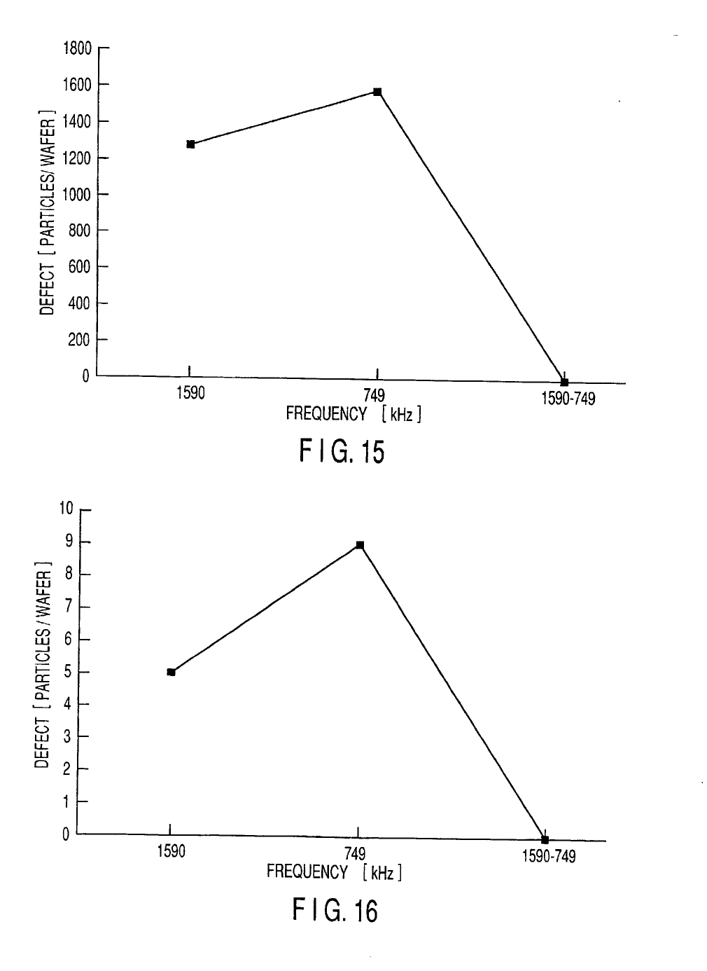

FIGS. 15 and 16 show the defects resulting from the application of the applying method of the third embodiment to the manufacture of the active areas of semiconductor devices and liquid-crystal displays, which will be explained in detail later. From FIGS. 15 and 16, it is seen that defects in the pattern can be reduced remarkably as in the second embodiment.

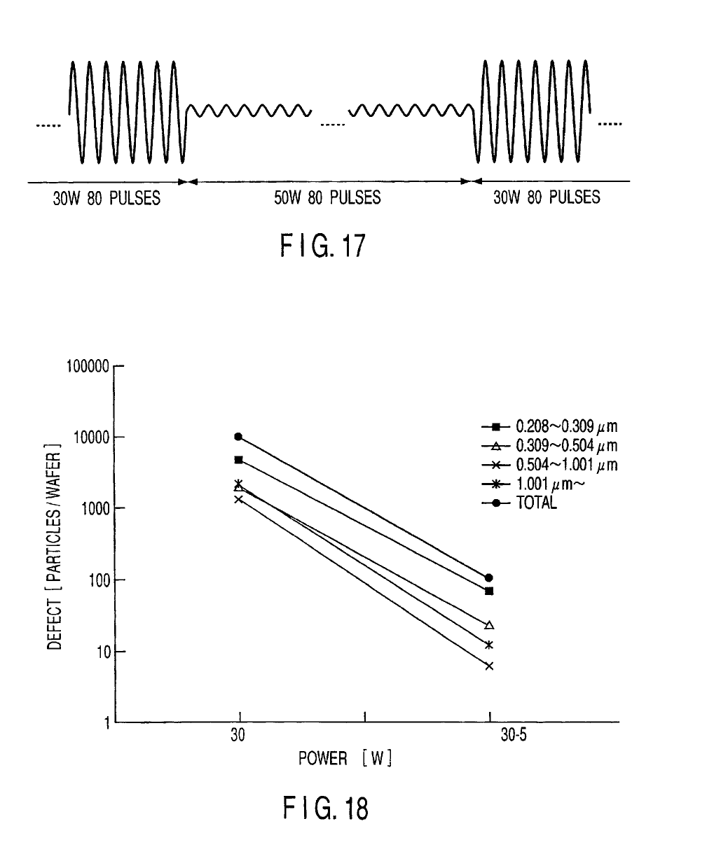

A fourth embodiment of the present invention will be explained by reference to FIG. 17. FIG. 17 shows a waveform of ultrasonic pulses applied in a washing method in the fourth embodiment. In the fourth embodiment, the pulse output is varied at predetermined time intervals, while the phase of ultrasonic waves is allowed to remain unchanged. In FIG. 17, the application of pulses alternates between 80 pulses of 30W and 80 pulses of 5W. As shown in FIG. 18, use of such a pulse-applying method reduces the number of defects to almost 1/100 of that in the continuous application of pulses of 30W, as explained in the second embodiment. The reason is considered to be that changing the phase in the middle acts so as to cancel the resonance, leading to a decrease in the number of defects.

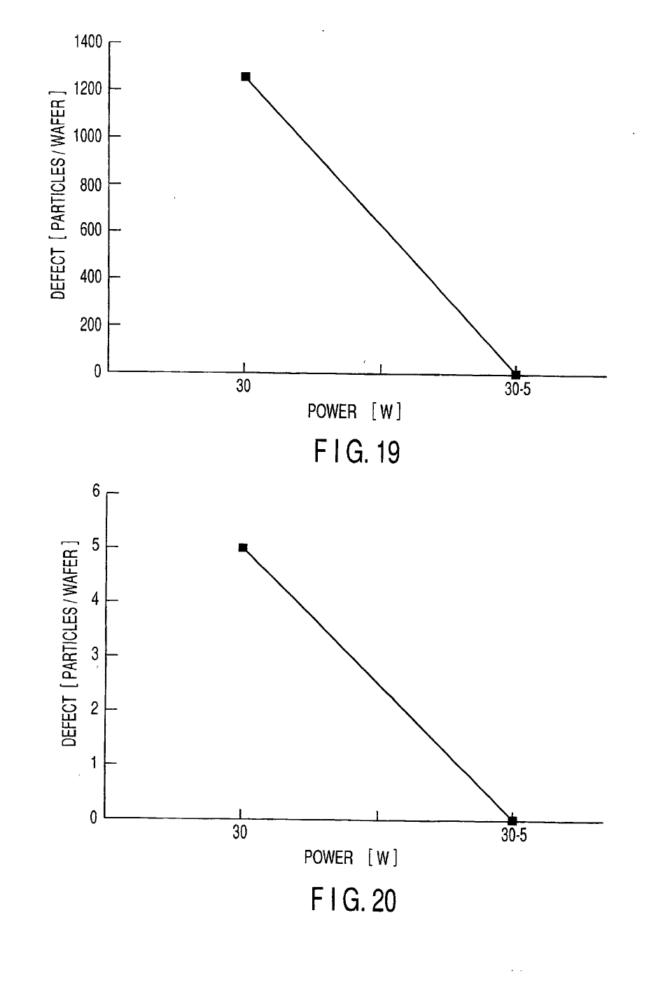

FIGS. 19 and 20 show the defects resulting from the application of the applying method of the fourth embodiment to the manufacture of the active areas of semiconductor devices and liquid-crystal displays, which will be explained in detail later. From FIGS. 19 and 20, it is seen that defects in the pattern can be reduced remarkably as in the second embodiment.

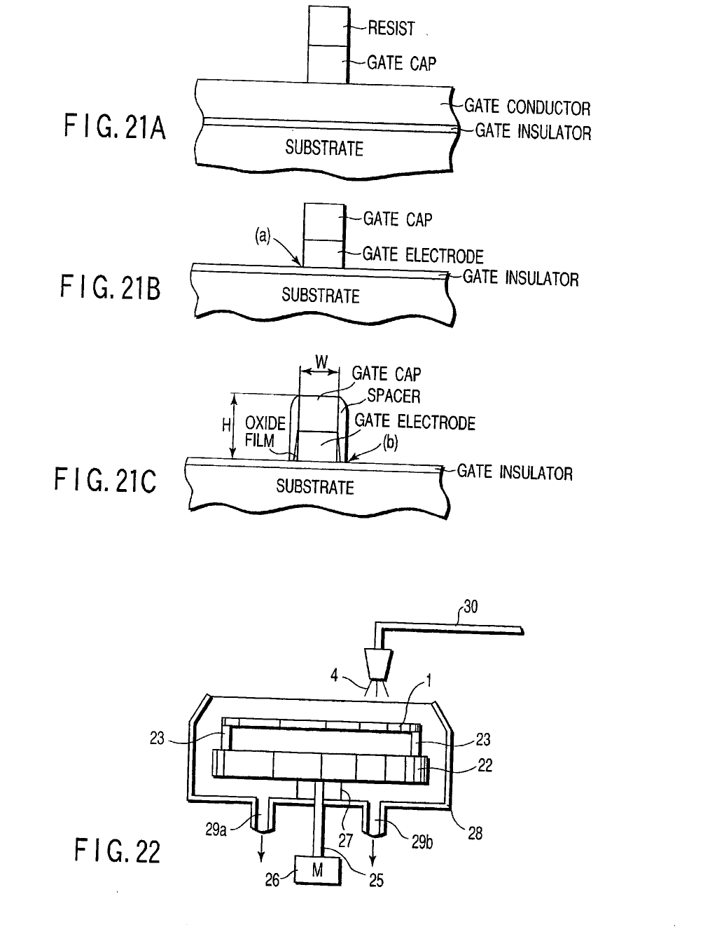

The process of forming the active area and gate conductor of a semiconductor device to which the above washing method is applied will be explained. When the design rules are not too strict, damage hardly becomes a problem. However, when the design rules are strict and begins to deal with the 0.2 μm level, damage is liable to occur. FIGS. 21A to 21C schematically show the processes of manufacturing semiconductor devices to which the present invention is applied.

First, for example, a gate insulating film (gate oxide film) is formed on a silicon substrate. On the gate insulating film, a gate conductor is formed. On the gate conductor, for example, SiN of which a gate cap is made is formed. On the SiN, a resist film is formed. Then, the resist film is exposed, developed, and patterned, thereby forming a mask. With this mask, SiN film is then etched so as to form a gate cap (FIG. 21A). Next, the resist is removed, the surface is washed, and thereafter the gate conductor is etched to the gate insulating film according to the mask pattern of the gate cap (FIG. 21B). Then, after the surface is washed, an oxide film is formed on the sidewall of the gate, thereby forming a spacer around the gate (FIG. 21C), which completes the gate of, for example, a DRAM.

In the manufacture of the aforementioned semiconductor device, after the etching process, the surface must be cleaned to form another layer in subsequent processes. In those processes, the ultrasonic washing method of the present invention is effective. When the design rules deal with the 0.2 μm level, a conventional ultrasonic washing method permits the part (a) of FIG. 21B or part (b) of FIG. 21C to come off, which increases the possibility that defects will occur in the pattern. If particles were not removed at all in the above-described processes, the yield would be less than 50% in the case of the design rules for, for example, 0.13 μm or less. The same holds for a conventional ultrasonic washing method. The application of the washing method of the present invention, however, reduces the number of defects in the pattern to almost 0 as described above, which proves the present invention very effective. It is desirable that the present invention should be applied to semiconductor devices complying with the design rules for 0.2 μm or less as described above. Furthermore, the present invention is more effective in applying to semiconductor devices with an aspect ratio (for example, H/W in FIG. 21C) of 1 or more. In addition, the invention is effective in applying to metal wires of 0.7 μm or less.

Next, an example of applying the present invention to the process of forming the gate of a P-Si TFT liquid-crystal display will be explained. In the basic process, after an SiN film, an SiO₂ film, and an a-Si film are formed, the a-Si film is washed. Thereafter, the a-Si film is annealed and polymerized. Then, a mask is formed. With this mask, the poly-Si film is etched, thereby forming a poly-Si island, which is to become a gate. The surface of the poly-Si land is then washed. After an insulating film and a metal film are formed on the poly-Si film, a resist film is formed. With the resist film, exposing and developing are done to etch the metal film to form a gate line.

In the case of a liquid-crystal display, its area is larger than that of a semiconductor. To improve the displaying capability, it is desirable to make the opening section larger. Therefore, it is necessary to make the pixel section larger and the peripheral circuit section, including a driver, smaller.

Since the process of manufacturing liquid-crystal displays requires its large area to be washed in a shorter time than the process of manufacturing semiconductor devices does, ultrasonic washing needs high electric power. The number of defects in a conventional washing method is 10 or less as shown in, for example, FIG. 12. Since the liquid-crystal display has no redundant circuit, those defects are fatal. When the washing method of the present invention is applied to the above washing process, however, the number of defects is 0 as shown in, for example, FIG. 12, which proves every effective. In the case of the semiconductor, the design rules for 0.2 μm or less and an aspect ratio of 1 are preferable. In the case of the liquid-crystal display, it is desirable that the washing method of the present invention should be applied when the design rules are for 5 μm or less and the aspect ratio is 0.05 or more. Furthermore, it is desirable that the present invention should be applied to metal wires with a width of 5 μm or less.

Next, an ultrasonic washing apparatus using the above-described washing method will be explained. FIG. 22 is a pictorial diagram of the washing section of the ultrasonic washing apparatus.

The ultrasonic washing apparatus, which is a sheet spin washing machine, holds a thing 1 to be washed, such as a semiconductor substrate, with pins 23 set up straight on a turntable 22 acting as a holding mechanism. The axis of rotation 25 of the turntable 22 is supported by bearings 27 and rotated by a motor 26. The bearings 27 are secured to a casing 28. The casing 28 has an opening at its top. At the opening, an ultrasonic washing unit 30 is provided. The ultrasonic washing unit 30, which contains a vibrator and a diaphragm (both not shown), is so provided that it can move freely in parallel with the washing face of the thing 1 to be washed. At the bottom of the casing 28, outlets 29a and 29b for cleaning fluid 4 are provided.

With this configuration, the vibrator is driven by driving means (not shown) in an on-off manner at specific time intervals, thereby causing the ultrasonic washing unit 30 to supply the cleaning fluid 4 on which ultrasonic waves superimposed on the carrier wave have been applied to the washing face of the semiconductor substrate 1. The cleaning fluid then washes the semiconductor substrate (the thing 1 to be washed) without doing damage to the substrate.

As described above, according to the present invention, good ultrasonic washing can be done without causing damage.

Additional advantages and modifications will readily occur to those skilled in the art. Therefore, the present invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. An ultrasonic washing method of washing a thing to be washed by supplying ultrasonic-wave-applied cleaning fluid to the thing, said ultrasonic washing method comprising applying said ultrasonic wave to said cleaning fluid in such a manner that said ultrasonic wave is turned on and off repeatedly at specific time intervals.

2. The ultrasonic washing method according to claim 1, wherein said ultrasonic wave is superimposed on a pulse-like carrier wave.

3. The ultrasonic washing method according to claim 2, wherein a frequency of said carrier wave is lower than an oscillation frequency of said ultrasonic wave.

4. The ultrasonic washing method according to claim 1, wherein an oscillation frequency of said ultrasonic wave is 0.6 MHz or higher.

5. The ultrasonic washing method according to claim 1, wherein a duty ratio of the carrier wave is 80% or less.

6. A washing method comprising:
a first step of washing a thing to be washed by applying a first ultrasonic wave; and
a second step of washing the thing by applying a second ultrasonic wave.

7. The washing method according to claim 6, wherein said first ultrasonic wave and said second ultrasonic wave are applied to the thing for washing, while being alternated at predetermined time intervals.

8. The washing method according to claim 6, wherein the oscillation frequency of said ultrasonic wave is 0.6 MHz or higher.

9. The washing method according to claim 6, wherein said first ultrasonic wave differs from said second ultrasonic wave in any one of phase, wavelength, and amplitude.

10. The washing method according to claim 9, wherein the wavelength of said second ultrasonic wave is different from an integral multiple of the wavelength of said first ultrasonic wave or from 1/n (n is an integer) of the wavelength of said first ultrasonic wave.

11. The washing method according to claim 9, wherein said first ultrasonic wave and said second ultrasonic wave are applied to the thing for washing, while being alternated at predetermined time intervals.

12. The washing method according to claim 9, wherein an oscillation frequency of said ultrasonic wave is 0.6 MHz or higher.

13. A semiconductor device manufacturing method comprising:
a first step of washing a surface at which a pattern including an island-like structure with a width of 0.2 μm or less and an aspect ratio of 1.0 or more has been formed by applying a first ultrasonic wave; and
a second step of applying a second ultrasonic wave for washing.

14. The semiconductor device manufacturing method according to claim 13, wherein said first ultrasonic wave differs from said second ultrasonic wave in any one of phase, wavelength, and amplitude.

15. A semiconductor device manufacturing method comprising:
a first step of washing a surface at which metal wires are exposed by applying a first ultrasonic wave; and
a second step of applying a second ultrasonic wave for washing.

16. The semiconductor device manufacturing method according to claim 15, wherein said first ultrasonic wave differs from said second ultrasonic wave in any one of phase, wavelength, and amplitude.

17. A method of manufacturing matrix-type display devices, comprising:
a first step of washing a surface at which Si or metal wires are exposed by applying a first ultrasonic wave; and
a second step of applying a second ultrasonic wave for washing.

18. The method according to claim 17, wherein said first ultrasonic wave differs from said second ultrasonic wave in any one of phase, wavelength, and amplitude.
